(19) United States
(12) Patent Application Publication
(10) Pub. No.: US 2024/0428011 A1
(43) Pub. Date: Dec. 26, 2024

(54) SYSTEM AND METHOD FOR NATURAL LANGUAGE BASED COMMAND RECOGNITION

(71) Applicant: VERIZON PATENT AND LICENSING INC., Basking Ridge, NJ (US)

(72) Inventors: Karthick KALIANNAN NEELAMOHAN, Namakkal (IN); Tarun NAGPAL, Bangalore (IN); Kunal SACHDEVA, Kanpur (IN); David SKURATOWICZ, Felton, CA (US); Sarat KOLLIMARLA, Jersey City, NJ (US)

(73) Assignee: VERIZON PATENT AND LICENSING INC., Basking Ridge, NJ (US)

(21) Appl. No.: 18/337,620

(22) Filed: Jun. 20, 2023

(51) Int. Cl. G06F 40/40

(52) U.S. Cl. CPC G06F 40/40

(57) ABSTRACT

A natural language processing (NLP) framework allows for receiving, recognizing, and performing actions in relation to multi-party communications (MPC) through interactive conversations with a user. In an embodiment, the NLP framework allows a user to conduct an interactive conversation with a conversation engine and provide it, through natural language inputs, with commands or requests related to MPCs.

### BACKGROUND

Interpersonal and multi-party communications (MPCs) such as conferences, meetings, and calls are the cornerstone of enterprise development and growth. With the rapid adoption of video based communications as the de facto method for communicating with teammates and colleagues, the number of communications and the amount of data regarding such communications has increased exponentially. Current methods of summarizing or recalling the content of such communication are essentially limited to manual notes by participants or long unreliable digital transcripts that still require human input for context and relevancy determination.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram illustrating an example environment within which the systems and methods disclosed herein could be implemented according to some embodiments.

FIG. 2 is a block diagram illustrating components of a natural language (NL) conversation system according to some embodiments.

FIG. 3 is a flow diagram illustrating a method for determining an action related to an MPC based on a user input according to an embodiment.

FIG. 4 is a flow diagram illustrating a method for generating a trained machine learning (ML) model according to an embodiment.

FIG. 5 illustrates an example event timeline according to some embodiments.

FIG. 6 is a block diagram of a device according to some embodiments.

### DETAILED DESCRIPTION

The present disclosure provides for a natural language processing (NLP) framework for receiving, recognizing, and performing actions in relation to multi-party communications (MPC) through interactive conversations with a user. In an embodiment, the NLP framework allows a user to conduct an interactive conversation with a conversation engine and provide it, through natural language inputs, with commands or requests related to MPCs. Natural language inputs are a form of user input that is provided in a natural human language rather than in a coded or technical language. For example, this can be in the form of text (e.g., typing a question into a message or chat application) or speech (e.g., asking a voice-activated assistant to perform a task).

In some embodiments, a command can be a request to summarize an MPC, chat, or meeting (used interchangeably) and provide a resulting summary to the user. In some embodiments, the command can include a request to provide the MPC summary periodically (e.g., a weekly summary every Monday). In some embodiments, the command can include specifications or parameters of the summary. For example, in some embodiments, a summary parameter can include a date, a time range (e.g., the last 10 minutes of a meeting, the first hour), and a desired summary length.

In some embodiments, a command can be a request to prepare and/or send a message (e.g., an email or instant message). In some embodiments, the message can be related to the MPC. For example, in some embodiments, the command can include a request to send a message to at least one participant with an MPC summary. In some embodiments, a command to prepare a message can include a message parameter. For example, in some embodiments, a message parameter can be whether the user would like a short message or a lengthy message. In some embodiments, the message can be directed to the participants of the MPC or a third party. In some embodiments, the command can be a request to schedule another MPC. In some embodiments, the command can include the same participants as the original MPC, new participants, or a combination of both.

In some embodiments, a command can be a follow-on command related to a response from the conversation engine. For example, in some embodiments, after generating an MPC summary, the user can command the conversation engine to prepare and send a message including the MPC summary. In some embodiments, a follow-on command can be a request expand or shorten a message.

In some embodiments, a command can be a request to provide a list of one or more follow-up items related to the MPC (e.g., send a message, schedule another meeting). In some embodiments, a follow-on command can be a command to the conversation engine to perform a follow-up item from a list of follow-up items related to the MPC.

In some aspects, the techniques described herein relate to a method for determining a candidate action and providing an action output. In some aspects, the method includes receiving a natural language (NL) user input from a user where the user input includes a command related to a multi-party communication (MPC). In some aspects, the method further includes obtaining MPC data associated with the MPC and determining a candidate action related to the MPC based on the user input. In some aspects, the method can also include generating an action output corresponding to the candidate action based on the user input and the MPC data and providing the action output to the UE to be presented to the user.

In some aspects, the user input can be a natural language (NL) input in text format or audio format. In some aspects, the user input can be received through a Hypertext Transfer Protocol (HTTP) request.

In some aspects, the command can include MPC identifiers corresponding to the MPC. In some aspects, the MPC identifiers can be used to access and retrieve the MPC data from a database.

In some aspects, the candidate action can be determined by applying a trained command recognition model including a Bidirectional Encoder Representations from Transformers (BERT) architecture to the user input. In some embodiments, the action output can be generated by applying a trained ML model including a Bidirectional and Auto-Regressive Transformers (BART) architecture to the MPC data.

In some aspects, the techniques described herein relate to a non-transitory computer-readable storage medium for storing instructions executable by a processor. In some aspects, the instructions can include receiving a user input from a UE of a user where the NL input includes a command related to an MPC. In some aspects, the instructions can also include obtaining MPC data associated with the MPC and determining a candidate action related to the MPC based on the user input. In some aspects, the instructions can further include generating an action output corresponding to the candidate action based on the user input and the MPC data and providing the action output to the UE to be presented to the user.

In some aspects, the techniques described herein relate to a device comprising a processor configured to receive an user input from a UE of a user, the NL input including a command related to an MPC, and obtain MPC data associated with the MPC. In some aspects, the processor is further configured to determine a candidate action related to the MPC based on the user input, generate an action output corresponding to the candidate action based on the user input and the MPC data, and provide the action output to the UE to be presented to the user.

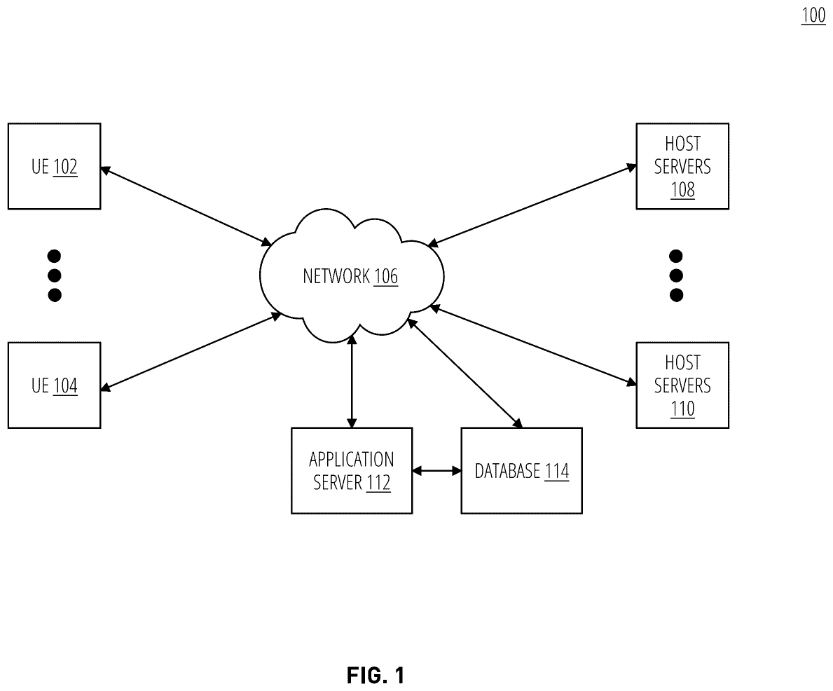

FIG. 1 is a block diagram illustrating an example environment within which the systems and methods disclosed herein could be implemented according to some embodiments.

FIG. 1 shows components of a general environment in which the systems and methods discussed herein may be practiced. Not all the components may be required to practice the disclosure, and variations in the arrangement and type of the components may be made without departing from the spirit or scope of the disclosure. As shown, system 100 can include user equipment (UE) 102-104, network 106, host servers 108-110, application server 112, and database 114.

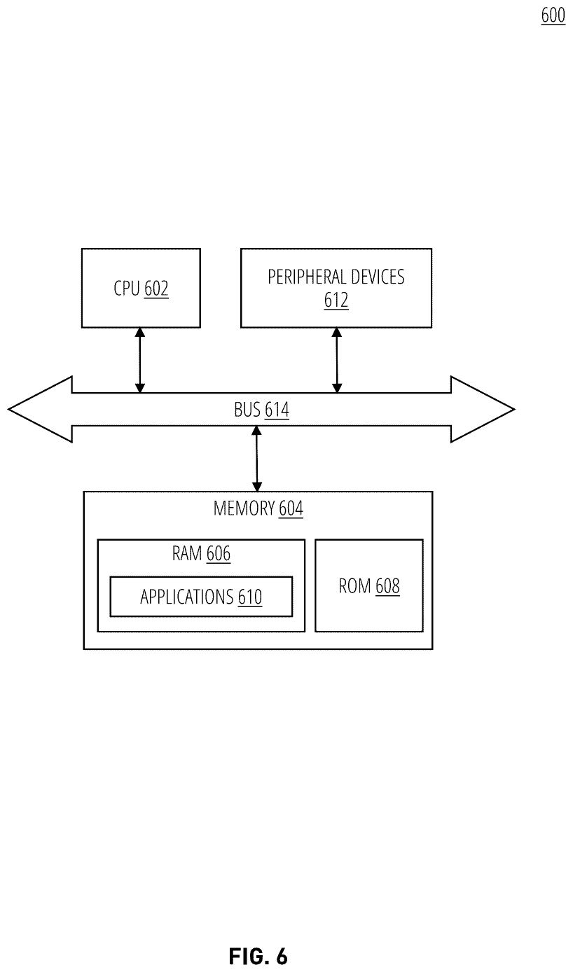

In the illustrated embodiment, UE 102-104 can communicate with host servers 108-110 and application server 112 via network 106. In some embodiments, UE 102-104 can include virtually any computing device capable of communicating with other UE, devices, or servers over a network, such as network 106. In some embodiments, UE 102-104 may be capable of sending or receiving signals, such as via a wired or wireless network, or may be capable of processing or storing signals, such as in memory as physical memory states. As examples, UE 102-104 can include mobile phones, smart devices, tablets, laptops, sensors, IoT devices, autonomous machines, unmanned aerial vehicles (UAVs), wired devices, wireless handsets, and any other devices equipped with a cellular or wireless or wired transceiver, whether portable or non-portable. In some embodiments, UE 102-104 can also be described generally as client devices. In some embodiments, UE 102-104 can be devices 600 as described with respect to FIG. 6.

In some embodiments, UE 102-104 can include at least one client application or program that is configured to communicate with a host sever, such as, host servers 108-110 or application server 112. In some embodiments, the client application can include a capability to provide and receive textual content, graphical content, audio content, and the like. In some embodiments, the client application can further provide information that identifies itself and/or the UE including a type, capability, name, and the like.

According to some embodiments, network 106 can be configured to couple UE 102-104, host servers 108-110, and/or application server 112. In some embodiments, network 106 can be a wired network, a wireless network, or a combination thereof. In some embodiments, network 106 is enabled to employ any form of computer readable media or network for communicating information from one electronic device to another. In some embodiments, network 106 can include the Internet, a local area network (LAN), a wireless LAN, a wide area network (WAN), a mobile edge computing (MEC) network, a private network, a cellular network, and the like. According to some embodiments, a “network” should be understood to refer to a network that may couple devices so that communications may be exchanged (e.g., between a server and a client device or between servers) including between wireless devices coupled via a wireless network, for example. In some embodiments, a network can also include mass storage or other forms of computer or machine readable media (e.g., database 114), for example.

In some embodiments, network 106 can include an access network and/or core network (not shown) of a mobile network. In general, the access network can include at least one base station that is communicatively coupled to the core network and coupled to zero or more UE 102-104. In some embodiments, the access network can comprise a cellular access network, for example, a fifth-generation (5G) network or a fourth-generation (4G) network. In one embodiment, the access network can comprise a NextGen Radio Access Network (NG-RAN), which can be communicatively coupled to UE 102-104. In an embodiment, the access network can include a plurality of base stations (e.g., eNodeB (eNB), gNodeB (gNB)) communicatively connected to UE 102-104 via an air interface. In some embodiments, the air interface can comprise a New Radio (NR) air interface. For example, in some embodiments, in a 5G network, UE 102-104, host servers 108-110, and/or application server 112 can be communicatively coupled to each other and to other devices. And, in some embodiments, for example, such coupling can be via Wi-Fi functionality, Bluetooth, or other forms of spectrum technologies, and the like.

In some embodiments, the access network and/or core network may be owned and/or operated by a service provider or an NO and provides wireless connectivity to UE 102-104 via the access network. In some embodiments, the core network can be communicatively coupled to a data network. In some embodiments, the data network can include one or more host servers 108-110. In some embodiments, network 106 can include one or more network elements. In some embodiments, network elements may be physical elements such as router, servers and switches or may be virtual Network Functions (NFs) implemented on physical elements.

According to some embodiments, host servers 108-110 and/or application server 112 can be capable of sending or receiving signals, such as via a wired or wireless network (e.g., network 106), or may be capable of processing or storing signals, such as in memory as physical memory states. In some embodiments, host servers 108-110, application server 112 can store, obtain, retrieve, transform, or provide content and/or content data in any form, known or to be known, without departing from the present disclosure.

As used herein, a “server” should be understood to refer to a service point which provides processing, database, and communication facilities. In some embodiments, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

According to some embodiments, devices capable of operating as a server (e.g., host servers 108-110 or application server 112) may include, as examples, dedicated rack-mounted servers, desktop computers, laptop computers, set top boxes, integrated devices combining various features, such as two or more features of the foregoing devices, or the like. In some embodiments, host servers 108-110 and/or application server 112 can be devices 600 as described with respect to FIG. 6.

Moreover, although FIG. 1 illustrates host servers 108-110 and application server 112 as single computing devices, respectively, the disclosure is not so limited. For example, one or more functions of host server host servers 108-110 and/or application server 112 can be distributed across one or more distinct computing devices.

In some embodiments, host servers 108-110 and/or application server 112 can implement devices or engines that are configured to provide a variety of services that include, but are not limited to, email services, instant messaging (IM) services, streaming and/or downloading media services, search services, photo services, web services, social networking services, news services, third-party services, audio services, video services, advertising services, mobile application services, NLP services, or the like. In some embodiments, in addition to application server 112, host servers 108-110 can also be referred to as application servers. In some embodiments, application servers can provide the foregoing services to a user upon the user being authenticated, verified, or identified by the service. In some embodiments, users can access services provided by host servers 108-110 and/or application server 112 via the network 106 using UE 102-104.

In some embodiments, applications, such as, but not limited to, news applications (e.g., Yahoo! Sports®, ESPN®, Huffington Post®, CNN®, and the like), mail applications (e.g., Yahoo! Mail®, Gmail®, and the like), streaming video applications (e.g., YouTube®, Netflix®, Hulu®, iTunes®, Amazon Prime®, HBO Go®, and the like), instant messaging applications, blog, photo or social networking applications (e.g., Facebook®, Twitter®, Instagram®, and the like), web conferencing applications (e.g., BlueJeans®, Zoom®, Skype®, and the like), search applications (e.g., Yahoo!® Search), and the like, can be hosted by host servers 108-110 and/or application server 112. Thus, in some embodiments, application server 112, for example, can store various types of applications and application related information including application data and user profile information (e.g., identifying and behavioral information associated with a user).

According to some embodiments, application server 112 can implement, in part or in its entirety, a conversation engine (e.g., conversation engine 202). In some embodiments, application server 112 can receive and analyze user commands entered by a user as natural language inputs to an application or a user interface (UI) of an application implemented in a UE (e.g., UE 102-104) and transmitted over the network 106 from the UE to the application server 112. In some embodiments, application server 112 can provide outputs from the conversation engine to the UE 102-104 over the network 106. In some embodiments, application server 112 can transmit instructions or otherwise provide data to other UE or other servers (e.g., host servers 108-110) in relation to an input or an output of the conversation engine.

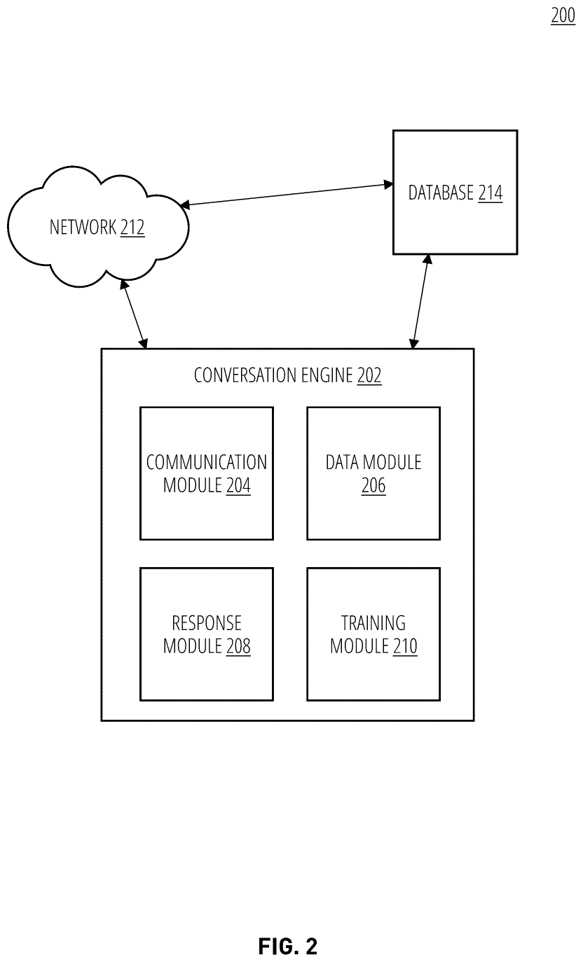

FIG. 2 is a block diagram illustrating components of a natural language (NL) conversation system according to some embodiments.

According to some embodiments, engagement system 200 can include conversation engine 202, network 212, and database 214. In some embodiments, conversation engine 202 can be a special purpose machine or processor and could be hosted by a cloud server (e.g., cloud web services server(s)), messaging server, application server, content server, social networking server, web server, search server, content provider, third party server, user's computing device, and the like, or any combination thereof. In some embodiments, conversation engine 202 can be implemented, in part or in its entirety, on application server 112 as discussed in relation to FIG. 1.

According to some embodiments, conversation engine 202 can be a stand-alone application that executes on a device (e.g., device 600 from FIG. 6). In some embodiments, conversation engine 202 can function as an application installed on the device, and in some embodiments, such application can be a web-based application accessed by the device (e.g., UE 102-104) over a network (e.g., network 106). In some embodiments, portions of the conversation engine 202 can function as an application installed on the device and some other portions can be cloud-based or web-based applications accessed by the computing device over a network (e.g., network 212), where the several portions of the conversation engine 202 exchange information over the network (e.g., between host servers 108-110 and/or application server 112). In some embodiments, the conversation engine 202 can be installed as an augmenting script, program or application (e.g., a plug-in or extension) to another application or portable data structure.

In some embodiments, the database 214 can be any type of database or memory, and can be associated with a host server or an application server on a network or a computing device. In some embodiments, portions of database 214 can be included in database 114 or be internal to a server or other device.

In some embodiments, a database 214 can include data and/or metadata associated with users, devices, and applications. In some embodiments, such information can be stored and indexed in the database 214 independently and/or as a linked or associated dataset (e.g., using unique identifiers). According to some embodiments, database 214 can store data and metadata associated with messages, images, videos, text, documents, items and services from an assortment of media, applications and/or service providers and/or platforms, and the like. Accordingly, any other type of known or to be known attribute or feature associated with a record, request, data item, media item, website, application, communication, and/or its transmission over a network (e.g., network traffic), content included therein, or some combination thereof, can be saved as part of the data/metadata in database 214.

In some embodiments, database 214 can include MPC data. In some embodiments, MPC data can include audio or video recordings. In some embodiments, recordings included in MPC data can be in any format, known or to be known, without departing from the scope of the present disclosure. In some embodiments, recordings included in MPC data can have associated recording metadata (e.g., date, time, length, size, author, type, format, etc.). In some embodiments, MPC data can be text transcripts of audio or video recordings.

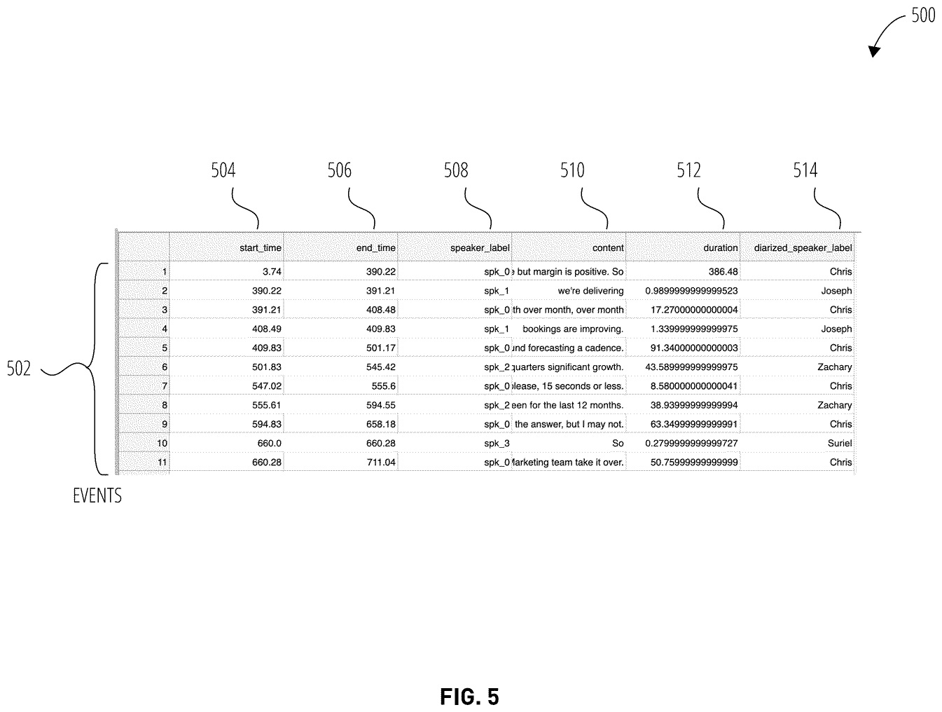

In some embodiments, MPC data can include event timelines corresponding to the MPC recordings. A non-limiting example embodiment of an event timeline is illustrated in FIG. 5. In some embodiments, when the MPC data includes a video recording, the MPC data can include a plurality of discrete video frames or sequence of frames and/or associated audio for each frame or sequence. In some embodiments, MPC data can correlate events with discrete video frames and/or audio snippets.

In some embodiments, MPC data can include speaker separated audio data (e.g., audio snippets attributed to individual speakers). In some of those embodiments, MPC data can include one or more discrete audio snippets of the MPC where each audio snippet has an associated speaker or timestamp (e.g., as metadata). In some embodiments, MPC data can include discrete text strings from a chat conversation among two or more speakers. In some embodiments, each discrete text string can correspond to an input or contribution by a speaker or participant. In some embodiments, each discrete text string can have an associated speaker or timestamp (e.g., as metadata).

In some embodiments, MPC data can include annotated MPC data associated with an MPC, MPC recording, event timeline, or a combination thereof. In some embodiments, annotated MPC data can include MPC data that has been labeled or otherwise annotated either manually by a human or automatically by a labeling algorithm. For example, in some embodiments, annotated MPC data can include an MPC summary corresponding to an MPC. In some embodiments, the MPC summary can be based on at least one of manual notes prepared by a human, the MPC recording, and/or an event timeline associated with the meeting. In some embodiments, annotated MPC data can include one or more follow-up items associated with the MPC.

According to some embodiments, network 212 can be any type of network such as, but not limited to, a wireless network, a local area network (LAN), wide area network (WAN), the Internet, or a combination thereof. In some embodiments, network 212 can facilitate connectivity of the conversation engine 202, and the database 214. Indeed, as illustrated in FIG. 2, the conversation engine 202 and database 214 can be directly connected by any known or to be known method of connecting and/or enabling communication between such devices and resources. In some embodiments, network 212 can include some or all the elements of network 106 as discussed in relation to FIG. 1.

The principal processor, server, or combination of devices that comprise hardware programmed in accordance with the special purpose functions herein is referred to for convenience as conversation engine 202, and includes communication module 204, data module 206, response module 208, and training module 210. It should be understood that the engine(s) and modules discussed herein are non-exhaustive, as additional or fewer engines and/or modules (or sub-modules) may be applicable to the embodiments of the systems and methods discussed. The operations, configurations and functionalities of each module, and their role within embodiments of the present disclosure will be discussed below.

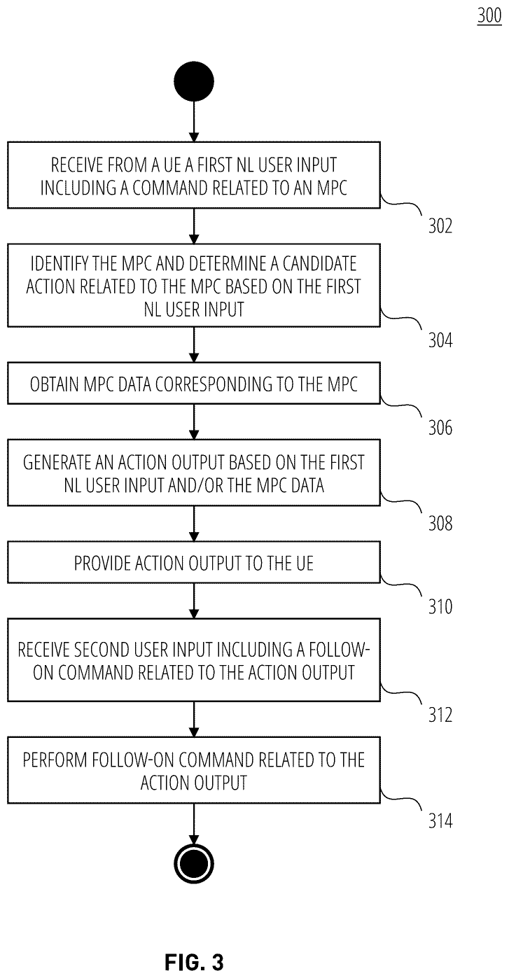

FIG. 3 is a flow diagram illustrating a method for determining an action related to an MPC based on a user input according to an embodiment.

In Step 302, method 300 can include receiving from a UE a first user input (e.g., a natural language input) including a command related to an MPC. In some embodiments, the first user input is received by a conversation engine (e.g., conversation engine 202). In some embodiments, the first user input can be a text input. In some embodiments, the first user input can be an audio input (e.g., captured by a microphone). In some embodiments, the first user input can be an audio component of a video input. In some of those embodiments, the first user input can be received in either an audio or video format. In those embodiments, in Step 302, the first user input can be received by a communication module 204 and passed to data module 206 to first extract the audio portion if received in video format, and then determine a raw transcript of the audio input or audio portion. In some embodiments, determining the raw transcript can include a speech-to-text or speech recognition model.

In some embodiments, the first user input can be provided through a User Interface (UI) of an application implemented on the UE. For example, in some embodiments, the application can be a messaging application or a web/multi-party conferencing application or other application where the user enters the user input using a chat function. In some embodiments, the application can capture the user input using a microphone and/or camera. In those embodiments, the user input can be transmitted from the UE to the conversation engine 202 (e.g., implemented in application server 112) through, for example, a Hypertext Transfer Protocol (HTTP) request.

In some embodiments, the command can be a request by the user to provide an action output related to an MPC. For example, in some embodiments, a user input can be “Please prepare a message with a Summary of our meeting earlier today” or “Can you tell me what were the follow-up items from yesterday's meeting?”. In some embodiments, the user input can be in any grammatical or syntactical form capable of being understood by a conversation engine. In some embodiments, the command can include information identifying the MPC (e.g., date, time, participants, location, work group, subgroups, or unique identifiers (e.g., a meeting ID). In some embodiments, the MPC can be a predetermined MPC. For example, in some embodiments, the MPC is the last MPC the user participated in. In some embodiments, the MPC is an MPC immediately preceding conversation engine receiving the user input in Step 302.

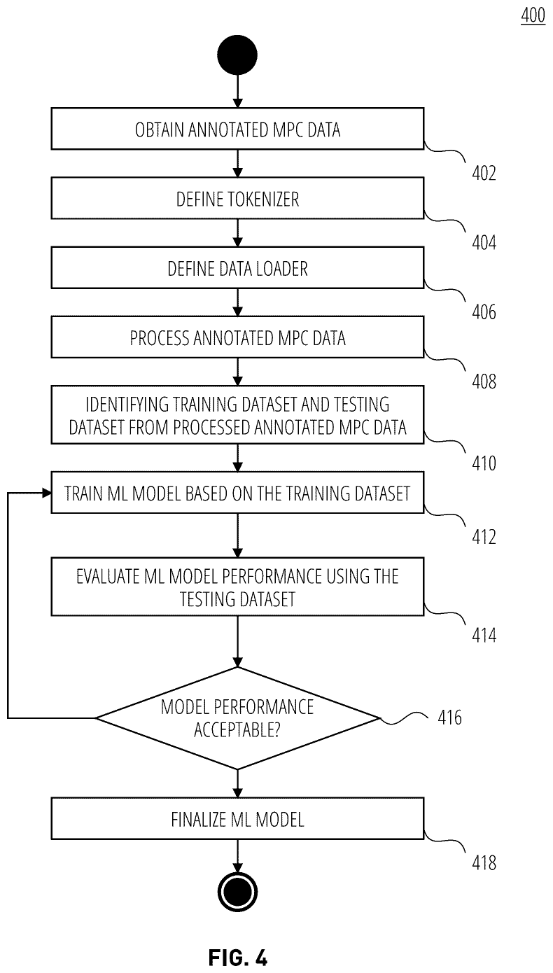

In Step 304, method 300 can include identifying the MPC (if needed) and determining a candidate action related to the MPC based on the user input. In some embodiments, the text form of the user input can be passed from the communication module 204/data module 206 to the response module 208 to be analyzed by response module 208 using a trained command recognition model (e.g., as discussed in relation to FIG. 4). In some embodiments, a command recognition model can be an ML model with a transformer based architecture such as the Bidirectional Encoder Representations from Transformers (BERT). In some embodiments, the command recognition model can be any transformer based architecture suitable for NLP including, but not limited to, for example, a Generative Pretrained Transformer (GPT) architecture, a Robustly Optimized BERT Approach (ROBERTa) architecture, an Electra architecture, or a Text-to-Text Transfer Transformer (T5) architecture. In some embodiments, upon determining the candidate action, response module 208 can invoke other ML models as described with respect to Steps 308 and 314 to generate an action output or perform a follow-on command related to the action output as described below.

In some embodiments, response module 208 can apply the command recognition model to the user input in text form to extract MPC identifiers corresponding to the MPC. For example, in some embodiments, MPC identifiers can include a date, time, participants, groups or subgroups, or unique identifiers (e.g., meeting ID) that enable the conversation engine 202 to identify the MPC.

In some embodiments, response module 208 can determine a candidate action related to the MPC based on the user input by applying the command recognition model to the user input. In some embodiments, from the user input, the command recognition model can provide the MPC identifiers, the candidate action, or both. In some embodiments, a candidate action can generate an MPC summary, prepare and/or transmit a message (e.g., an email), schedule another meeting (e.g., by preparing and sending a meeting request), generate a list of keywords or highlights, and convert or change the tone or style of an MPC transcript (e.g., MPC data) representing the content of the MPC. In some embodiments, converting or changing the tone of an MPC transcript can include converting the inputs or contributions of each MPC participant to another style or tone (e.g., formal, informal, polite, impolite, non-offensive/non-biased). In some embodiments, the candidate action can include generating automatic MPC summaries on a periodic basis of recurring MPCs. In some embodiments, the candidate action can include determining an engagement scores indicating a level of engagement of the participants to an MPC. In some embodiments, the candidate action can include determining outstanding actions or follow up items associated with the content of the MPC (e.g., what was discussed).

In Step 306, method 300 can include obtaining MPC data corresponding to the MPC identified in Step 304. In some embodiments, the response module 208 can interact with the communication module 204 and/or the data module 206 to obtain the MPC data from a database (e.g., databases 214) based on the MPC identifiers.

In Step 308, method 300 can include generating an action output based on the user input and/or the MPC data. For example, in an embodiment where the candidate action is generating an MPC summary, the action output can be the MPC summary. In an embodiment where the candidate action is preparing and sending a message, the action output can be a draft message. In an embodiment where the candidate action is scheduling another meeting, the action output can be a draft meeting invite. In some embodiments, where the candidate action is generating a list of keywords, the action output can be a list of keywords. In some embodiments, where the candidate action is converting or changing the tone of an MPC transcript, the action output can be a modified MPC transcript with the desired tone.

In some embodiments, the response module 208 can generate an MPC summary by applying a trained summarization model to the MPC data. In some embodiments, a summarization model can be a machine learning model with a transformer based architecture such as the Bidirectional and Auto-Regressive Transformers (BART) architecture. In some embodiments, the summarization model can be any transformer based architecture suitable for NLP including, but not limited to, for example, BERT, a Generative Pretrained Transformer (GPT) architecture, a Robustly Optimized BERT Approach (ROBERTa) architecture, an Electra architecture, or a Text-to-Text Transfer Transformer (T5) architecture. In some embodiments, a trained summarization model can be generated as discussed in relation to FIG. 4.

In some embodiments, the response module 208 can generate a modified MPC transcript by applying a trained tone/style transfer model to the MPC data. In some embodiments, a tone/style transfer model can be a machine learning model with a transformer based architecture such as the Bidirectional and Auto-Regressive Transformers (BART) architecture. In some embodiments, the tone/style transfer model can be any transformer based architecture suitable for NLP including, but not limited to, for example, BERT, a Generative Pretrained Transformer (GPT) architecture, a Robustly Optimized BERT Approach (ROBERTa) architecture, an Electra architecture, or a Text-to-Text Transfer Transformer (T5) architecture. In some embodiments, a trained tone/style transfer model can be generated as discussed in relation to FIG. 4.

In Step 310, method 300 can include providing the action output to the application implemented on the UE. In some embodiments, upon receipt the of the action output the application can present it to the user.

Optionally, in some embodiments, in Step 312, method 300 can include receiving from the UE a second user input including a follow-on command related to the action output. In some embodiments, the second user input can be a NL input. In some embodiments, the second user can be a non-NL input (e.g., selecting a button). In some embodiments, the second user input is received by a conversation engine (e.g., conversation engine 202). In some embodiments, the second user input can be a text input, an audio input, or an audio component of a video input. In some embodiments, where the second user input is an audio input, the input can be received by communication module 204 and passed to data module 206 to first extract the audio portion if received in video format, and then determine a raw transcript. In some embodiments, determining the raw transcript can include a speech-to-text or speech recognition model.

In some embodiments, the second user input can be provided through the UI of the application implemented on the UE. In some embodiments, the second user input can be transmitted from the UE to the conversation engine 202 (e.g., implemented in application server 112) through a Hypertext Transfer Protocol (HTTP) request.

In some embodiments, the follow-on command can be a request by the user to perform an operation related to the action output. For example, in some embodiments, the follow-on command can be a request to send a draft message, schedule a meeting, or generate and provide a modified MPC transcript.

In Step 314, method 300 can include performing the follow-on command in relation to the action output. For example, In some embodiments, performing the follow-on command can be sending the message, scheduling the meeting, or generating and providing a modified MPC transcript.

FIG. 4 is a flow diagram illustrating a method for generating a trained machine learning (ML) model according to an embodiment.

In Step 402, method 400 can include obtaining MPC data corresponding to an MPC. In some embodiments, MPC data can be annotated MPC data. In some embodiments, the data module 206 of engagement system 200 can retrieve the annotated MPC data from a database (e.g., database 214).

In some embodiments, annotated MPC data can be specific to the ML model being trained. In some embodiments, annotated MPC data can be MPC data with annotations provided by human reviewers. In some embodiments, annotated MPC data can include off-the-shelf datasets. For example, in some embodiments, annotated MPC data used for training a summarization model can include off-the-shelf datasets such as the AMI Meeting Corpus, the DialogSUM dataset, the XSUM dataset, and the SAMSUM dataset. As another example, in some embodiments, annotated MPC data used for training a tone/style transfer model can include off-the-shelf datasets such as the XFORMAL dataset and the Politeness5 dataset. In some embodiments, annotated MPC data can include data from publicly available social media datasets (e.g., Twitter®, Reddit®).

In Step 404, method 400 can include defining a tokenizer for the specific model being trained. In some embodiments, the tokenizer can convert MPC data or annotated MPC data into a data format suitable for training an ML mode. In some embodiments, a tokenizer converts text data into numerical data. In some embodiments, the data module 206 of engagement system 200 can select and implement a tokenizer based on the type of ML model being trained. For example, in some embodiments, to train a BART or BERT architecture-based model, training module 210 can implement the WordPiece tokenizer. In some embodiments, the tokenizer can be any tokenizer used for training BART or BERT architecture-based models.

In Step 406, method 400 can include defining a data loader. In some embodiments, the data module 206 can implement the data loader to manage the annotated MPC data as it is processed and passed to the ML model during training by the training module 210. In some embodiments, a data loader can be an off-the-shelf data loader such as the PyTorch DataLoader or the TensorFlow® data loader.

In Step 408, method 400 can include processing the annotated MPC data in preparation for training the ML model. In some embodiments, Step 408 can be performed by data module 206. In some embodiments, processing the annotated MPC data can include cleaning the data (e.g., address missing values entires, remove unrecognized/special characters, remove duplicates, etc.), normalizing or scaling the data by means of padding/truncation, and augmenting the data. In some embodiments, the output of Step 408 is processed annotated MPC data.

In Step 410, method 400 can include identifying a training dataset and a testing dataset from the processed annotated MPC data. In some embodiments, the training dataset can be used to train the model while the testing dataset can be used to evaluate the model's performance. In some embodiments, a third dataset—a validation dataset—can also be used during training to tune hyperparameters and make decisions on the training process. In some embodiments, the processed annotated MPC data can be split by the data module 206 based on predetermined ratios (e.g., 80% as training data, 20% as testing data). In some embodiments, data module 206 can shuffle or randomize the processed annotated MPC data prior to identifying the training and testing datasets.

In Step 412, method 400 can include training the ML model. In some embodiments, the training process can be performed by training module 210. As noted above, in some embodiments, the ML model can be the command recognition model, the summarization model, and the tone/style transfer model. In some embodiments, training the ML model can include initializing the model (e.g., by assigning small, random values to the model's weights or by using pre-trained weights); tokenizing the data in the training dataset using the tokenizer defined in Step 404; masking some of the tokens at random; making predictions for the masked tokens; calculating a loss based on the actual values of the removed tokens; and updating the model's parameters (e.g., weights). In some embodiments, these operations can be repeated until the model's performance on the training dataset or a validation dataset stabilizes or stops improving.

In Step 414, method 400 can include evaluating the ML model's performance using the testing dataset. In some embodiments, training module 210 can evaluate the model's performance by comparing the model's performance to a set of predetermined metrics. For example, in some embodiments, the predetermined metrics can be the ROUGE-1, ROUGE-2, ROUGE-L, or Perplexity evaluation metrics.

In Step 416, method 400 can include determining whether the ML model's performance is acceptable based on the results of the model's evaluation in Step 414. In some embodiments, if training module 210 determines that the model's performance is acceptable, then training module 210 finalizes the model in Step 418. If the model's performance is not acceptable then training module 210 repeats some or all of the training process. In some embodiments, the result of Step 418 is a trained ML model (e.g., a trained command recognition model, a trained summarization model, or a trained tone/style transfer model).

FIG. 5 illustrates an example event timeline according to some embodiments.

In some embodiments, an event timeline 500 can include a one or more events 502 and event data (504-514) for each event 502. In some embodiments, event data can include a start time 504, an end time 506, a duration 512, a content 510, a speaker label 508, or a diarized speaker label indicating a speaker or participant associated with the speaker label 508.

In some embodiments, for a given events 502, content 510 can include an input or contribution by the corresponding speaker or participant (e.g., as denoted by speaker label 508 or content 510). In some embodiments, as shown in FIG. 5, the contribution can be spoken words by the speaker. In some embodiments, the contribution can be a gesture or expression by the speaker and the content can be a description of the contribution. In some embodiments, the contribution can be a string of text entered into a chat. In some embodiments, the contribution can be a digital item (e.g., emoji, picture, video, audio, presentation, document). In some of those embodiments, the content 510 can include a description of the contribution (e.g., “spk_0/Chris has sent a smiling emoji”).

FIG. 6 is a block diagram of a device according to some embodiments.

As illustrated, the device 600 can include a processor or central processing unit (CPU) such as CPU 602 in communication with a memory 604 via a bus 614. Device 600 can also include one or more input/output (I/O) or peripheral devices 612. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 602 can comprise a general-purpose CPU. The CPU 602 can comprise a single-core or multiple-core CPU. The CPU 602 can comprise a system-on-a-chip (SoC) or a similar embedded system. In some embodiments, a graphics processing unit (GPU) can be used in place of, or in combination with, a CPU 602. Memory 604 can comprise a non-transitory memory system including a dynamic random-access memory (DRAM), static random-access memory (SRAM), Flash (e.g., NAND Flash), or combinations thereof. In one embodiment, the bus 614 can comprise a Peripheral Component Interconnect Express (PCIe) bus. In some embodiments, bus 614 can comprise multiple busses instead of a single bus.

Memory 604 illustrates an example of non-transitory computer storage media for the storage of information such as computer-readable instructions, data structures, program modules, or other data. Memory 604 can store a basic input/output system (BIOS) in read-only memory (ROM), such as ROM 608, for controlling the low-level operation of the device. The memory can also store an operating system in random-access memory (RAM) for controlling the operation of the device

Applications 610 can include computer-executable instructions which, when executed by the device, perform any of the methods (or portions of the methods) described previously in the description of the preceding Figures. In some embodiments, the software or programs implementing the method embodiments can be read from a hard disk drive (not illustrated) and temporarily stored in RAM 606 by CPU 602. CPU 602 may then read the software or data from RAM 606, process them, and store them in RAM 606 again.

The device 600 can optionally communicate with a base station (not shown) or directly with another computing device. One or more network interfaces in peripheral devices 612 are sometimes referred to as a transceiver, transceiving device, or network interface card (NIC).

An audio interface in Peripheral devices 612 produces and receives audio signals such as the sound of a human voice. For example, an audio interface may be coupled to a speaker and microphone (not shown) to enable telecommunication with others or generate an audio acknowledgment for some action. Displays in Peripheral devices 612 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 612 can comprise any input device arranged to receive input from a user. An illuminator in peripheral devices 612 can provide a status indication or provide light. The device can also comprise an input/output interface in peripheral devices 612 for communication with external devices, using communication technologies, such as USB, infrared, Bluetooth™, or the like. A haptic interface in peripheral devices 612 can provide a tactile feedback to a user of the client device.

A GPS receiver in peripheral devices 612 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device can include more or fewer components than those shown in FIG. 6, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, the subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “and,” “or,” or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, can be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can, in fact, be executed substantially concurrently, or the blocks can sometimes be executed in the reverse order, depending upon the functionality or acts involved.

These computer program instructions can be provided to a processor of a general-purpose computer to alter its function to a special purpose; a special purpose computer; ASIC; or other programmable digital data processing apparatus, such that the instructions, which execute via the processor of the computer or other programmable data processing apparatus, implement the functions or acts specified in the block diagrams or operational block or blocks, thereby transforming their functionality in accordance with embodiments herein.

For the purposes of this disclosure, a computer-readable medium (or computer-readable storage medium) stores computer data, which data can include computer program code or instructions that are executable by a computer, in machine-readable form. By way of example, and not limitation, a computer-readable medium may comprise computer-readable storage media for tangible or fixed storage of data or communication media for transient interpretation of code-containing signals. Computer-readable storage media, as used herein, refers to physical or tangible storage (as opposed to signals) and includes without limitation volatile and non-volatile, removable, and non-removable media implemented in any method or technology for the tangible storage of information such as computer-readable instructions, data structures, program modules or other data. Computer-readable storage media includes, but is not limited to, RAM, ROM, EPROM, EEPROM, flash memory or other solid-state memory technology, CD-ROM, DVD, or other optical storage, magnetic cassettes, magnetic tape, magnetic disk storage, or other magnetic storage devices, or any other physical or material medium which can be used to tangibly store the desired information or data or instructions and which can be accessed by a computer or processor.

For the purposes of this disclosure, a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer-readable medium for execution by a processor. Modules may be integral to one or more servers or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than or more than all the features described herein are possible.

Functionality may also be, in whole or in part, distributed among multiple components, in manners now known or to become known. Thus, a myriad of software, hardware, and firmware combinations are possible in achieving the functions, features, interfaces, and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example to provide a complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving, from a user equipment (UE), a natural language (NL) user input from a user, the user input including a command related to a multi-party communication (MPC);
obtaining MPC data associated with the MPC;
determining a candidate action related to the MPC based on the user input;
generating an action output corresponding to the candidate action based on the user input and the MPC data; and
providing, to the UE, the action output to be presented to the user.

2. The method of claim 1, wherein the command includes MPC identifiers corresponding to the MPC, the method further comprising obtaining the MPC data by accessing a database and retrieving the MPC data using the MPC identifiers.

3. The method of claim 1, further comprising determining the candidate action by applying a trained command recognition model to the user input, the command recognition model having a Bidirectional Encoder Representations from Transformers (BERT) architecture.

4. The method of claim 1, further comprising generating the action output by applying a trained ML model to the MPC data, the trained ML model having a Bidirectional and Auto-Regressive Transformers (BART) architecture.

5. The method of claim 4, further comprising training the ML model by:
obtaining annotated MPC data;
processing the MPC data by cleaning and normalizing the MPC data to generate processed annotated MPC data;
identifying a training dataset and a testing dataset from the processed annotated MPC data;
training an ML model using the training dataset;
evaluating the ML model using the testing dataset based on predetermined metrics, the predetermined metrics selected from the group comprising: ROUGE-1, ROUGE-2, ROUGE-L, and Perplexity evaluation metrics; and
generating the trained ML model based on whether the ML model evaluation is acceptable.

6. The method of claim 5, wherein the annotated MPC data includes data associated with at least one of an MPC recording, an event timeline, or a combination thereof.

7. The method of claim 1, further comprising:
receiving a second user input from the user, the second user input including a follow-on command related to the action output; and
performing the follow-on command with respect to the action output.

8. A non-transitory computer-readable storage medium for storing instructions executable by a processor, the instructions comprising:
receiving, from a user equipment (UE), a natural language (NL) user input from a user, the user input including a command related to a multi-party communication (MPC);
obtaining MPC data associated with the MPC;
determining a candidate action related to the MPC based on the user input;
generating an action output corresponding to the candidate action based on the user input and the MPC data; and
providing, to the UE, the action output to be presented to the user.

9. The non-transitory computer-readable storage medium of claim 8, wherein the command includes MPC identifiers corresponding to the MPC and wherein the instructions further comprise obtaining the MPC data by accessing a database and retrieving the MPC data using the MPC identifiers.

10. The non-transitory computer-readable storage medium of claim 8, the instructions further comprising determining the candidate action by applying a trained command recognition model to the user input, the command recognition model having a Bidirectional Encoder Representations from Transformers (BERT) architecture.

11. The non-transitory computer-readable storage medium of claim 8, the instructions further comprising generating the action output by applying a trained ML model to the MPC data, the trained ML model having a Bidirectional and Auto-Regressive Transformers (BART) architecture.

12. The non-transitory computer-readable storage medium of claim 8, the instructions further comprising:
obtaining annotated MPC data;
processing the MPC data by cleaning and normalizing the MPC data to generate processed annotated MPC data;
identifying a training dataset and a testing dataset from the processed annotated MPC data;
training an ML model using the training dataset;
evaluating the ML model using the testing dataset based on predetermined metrics, the predetermined metrics selected from the group comprising: ROUGE-1, ROUGE-2, ROUGE-L, and Perplexity evaluation metrics; and
generating the trained ML model based on whether the ML model evaluation is acceptable.

13. The non-transitory computer-readable storage medium of claim 12, wherein the annotated MPC data includes data associated with at least one of an MPC recording, an event timeline, or a combination thereof.

14. The non-transitory computer-readable storage medium of claim 8, the instructions further comprising:
receiving a second user input from the user, the second user input including a follow-on command related to the action output; and
performing the follow-on command with respect to the action output.

15. A device comprising a processor configured to:
receive, from a user equipment (UE), a natural language (NL) user input from a user, the user input including a command related to a multi-party communication (MPC);
obtain MPC data associated with the MPC;
determine a candidate action related to the MPC based on the user input;
generate an action output corresponding to the candidate action based on the user input and the MPC data; and
provide, to the UE, the action output to be presented to the user.

16. The device of claim 15, wherein the command includes MPC identifiers corresponding to the MPC, the processor further configured to obtain the MPC data by accessing a database and retrieving the MPC data using the MPC identifiers.

17. The device of claim 15, the processor further configured to determine the candidate action by applying a trained command recognition model to the user input, the command recognition model having a Bidirectional Encoder Representations from Transformers (BERT) architecture.

18. The device of claim 15, the processor further configured to generate the action output by applying a trained ML model to the MPC data, the trained ML model having a Bidirectional and Auto-Regressive Transformers (BART) architecture.

19. The device of claim 15, the processor further configured to:
receive a second user input from the user, the second user input including a follow-on command related to the action output; and
perform the follow-on command with respect to the action output.

20. The device of claim 15, the processor further configured to:
obtain annotated MPC data, the annotated MPC data including data associated with at least one of an MPC recording, an event timeline, or a combination thereof;
process the MPC data by cleaning and normalizing the MPC data to generate processed annotated MPC data;
identify a training dataset and a testing dataset from the processed annotated MPC data;
train an ML model using the training dataset;
evaluate the ML model using the testing dataset based on predetermined metrics, the predetermined metrics selected from the group comprising: ROUGE-1, ROUGE-2, ROUGE-L, and Perplexity evaluation metrics; and
generating the trained ML model based on whether the ML model evaluation is acceptable.
